(19) United States
(12) Patent Application Publication
(10) Pub. No.: US 2003/0041159 A1
(43) Pub. Date: Feb. 27, 2003

(54) Systems and method for presenting customizable multimedia presentations

(76) Inventors: David Tinsley, Campbell, CA (US); Frederick Joseph Patton II, San Jose, CA (US)

Correspondence Address: Bao Tran, 3103 Glen Alto Court, San Jose, CA, 95148, US

(21) Appl. No.: 09/932,345

(22) Filed: Aug. 17, 2001

(51) Int. Cl. G06F 15/16; H04N 7/16; H04H 9/00

(52) U.S. Cl. 709/231; 725/14; 709/204

(57) ABSTRACT

A method for presenting customized content to a viewer by archiving the viewer's behavior on a server coupled to a wide area network and collecting the viewer's preferences over time; receiving a request for a selected audio or video content; dynamically generating customized audio or video content according to the viewer's preferences; merging the dynamically generated customized audio or video content with the selected audio or video content; and displaying the customized audio or video content to the viewer.

The present application is related to application Ser. No. ______, entitled “SYSTEMS AND METHODS FOR DISPLAYING A GRAPHICAL USER INTERFACE”, application Ser. No. ______, entitled “SYSTEMS AND METHODS FOR AUTHORING CONTENT”, and application Ser. No. ______, entitled “INTELLIGENT FABRIC”, all of which are commonly owned and are filed concurrently herewith, the contents of which are hereby incorporated by reference.

### BACKGROUND

The present invention relates to systems and methods for supporting dynamically customizable contents.

The communications industry has traditionally included a number of media, including television, cable, radio, periodicals, compact disc (CDs) and digital versatile discs (DVDs). With the emergence of the Internet and wireless communications, the industry now includes Web-casters and cellular telephone service providers, among others. One over-arching goal for the communications industry is to provide relevant information upon demand by a user. For example, television, cable and radio broadcasters and Web-casters transmit entertainment, news, educational programs, and presentations such as movies, sport events, or music events that appeal to as many people as possible.

Traditionally, the industry provides a single publication, video stream or sound stream that is viewed or listened by a user. Under this model, the user has no control over the objects or listening/viewing perspectives from which to listen/view the event of interest. For videos, a video editor or broadcast video producer dictates the composition of the video production viewed by a passive viewer. In contrast to the wide range of viewing perspectives and object selection available to a viewer when the viewer is actually present at an event of interest, the traditional presentation is constrained to showing objects that are pre-selected by a video producer. In addition, the television viewer must view the objects selected by the video producer from the viewing perspectives dictated by the producer. In conventional video, viewers are substantially passive. All that viewers are allowed to do is to control the flow of video by pressing buttons such as play, pause, fast-forward or reverse. These controls essentially provide the passive viewer only one choice for a particular segment of recorded video information: the viewer can either see the video (albeit at a controllable rate), or skip it. In some cases, this is an acceptable arrangement, especially when a television or video viewer has little or no interest in the event and therefore has no preference regarding the perspectives or objects under view.

In addition to viewing control, there are many programs that can use interactivity. For example, as mentioned in U.S. Pat. No. 6,263,501 to Schein, et al., these programs can request viewer action such as purchasing an advertised product, making a monetary contribution, responding to a survey, answering a question, or participating in contests with other viewers.

The industry also uses advertising to inform or teach consumers of a particular subject matter. An advertisement may be a paid announcement of goods or services for sale, a public notice, or any other such mechanism for informing the general public of a particular subject matter. In order for advertising to be effective, however, the advertisement should reach a large number of people and the advertisement should include information that is easy to recall. In the television industry, an advertisement is a full-motion or still image video segment that is inserted into the video programming. The video segment is typically short, for example thirty to sixty seconds. Unfortunately, it is often difficult for an advertiser to provide detailed information regarding the product, service, or public notice during such a short time period.

With the existing system, a viewer must be motivated to request information. Viewers will often forget the advertisement or simply lose motivation to spend money or request information after the commercial or program is over. Another problem is that companies sponsoring these commercials or programs would often like to provide their viewers with additional information, if the viewers could be identified or if the viewer requests the additional information. Since airtime is limited, advertisers conventionally provide supplementary advertising information, such as a telephone number, mailing address, or an Internet web site address so that viewers may obtain additional information at a later time. In order to retain this supplementary advertising information, a viewer must quickly commit the information to memory during the conventional thirty or sixty-second video segment. Alternatively, the viewer may be compelled to search for a paper and pen in order to write down the supplementary information. Unfortunately, the supplementary information may not be accurately committed to memory or recorded. In other words, a conventional television advertisement may not effectively provide information to the viewer because the viewer cannot successfully remember or record the supplementary advertising information.

When the telephone number, advertiser address, or the Internet web site address is successfully remembered or recorded, it is necessary for the viewer to undertake later communication with the advertiser if the viewer is interested in learning more about the advertised product, service, or public notice. For example, following the advertisement, the viewer may call the advertiser over a conventional telephone line, send a letter to the advertiser using conventional mail delivery, or access the advertiser's web site through a computer system. Since making the request is inconvenient to the viewer, and the viewer may be less likely to request the information. Additionally, reliance on the web pages can be problematic, since web pages can become outdated and web links become invalid.

### SUMMARY

A method for presenting customized content to a viewer by archiving the viewer's behavior on a server coupled to a wide area network and collecting the viewer's preferences over time; receiving a request for a selected audio or video content; dynamically generating customized audio or video content according to the viewer's preferences; merging the dynamically generated customized audio or video content with the selected audio or video content; and displaying the customized audio or video content to the viewer.

Advantages of the invention may include one or more of the following. The system combines the advantages of traditional media with the Internet in an efficient manner so as to provide text, images, sound, and video on-demand in a simple, intuitive manner. The system provides viewers with additional information associated with a particular program. As a television viewer is browsing through the programs, he or she may wish to obtain more information relating to specific areas of interest or concerns associated with the show, such as the actors, actresses, other movies released during the same time period, or travel packages or promotions that may be available through primary, secondary or third party vendors. The system can offer information to the viewer even with the multitude of programs broadcast every day. In addition, the system can rapidly update and provide the available information to viewers in real time. The system can effectively deliver customized content, including advertising, to viewers. This can be done in connection with interactive video programming. The system also provides a ready and efficient method to facilitate an exchange of information between television viewers and producers, promoters and advertisers during the broadcast of the commercial or program.

The system turns traditional content in a contextual database and continues to do so over time (well after initial content creation), so that the viewers are always presented with the most current, focused information tree through the context of the content in question. This experience is different from web browsing with the spaghetti of web links found on a typical web page, both in focus and reliability of the link. As related contents reside on a well-maintained central server in a network, the chances for broken links are reduced. These contextual choices may result in the acquisition of additional content that may be of like or different content type, i.e. audio visual data, text, charts, and interactive information models, such as a spread sheet with input fields such as for a personal training record. In the latter case, not only can the viewer watch and work out to their favorite training video, they could record their progress, and the system could provide feedback in regards to their progress, such as suggesting protein supplements, which could well be available through the system. The system would understand what segment of the viewership takes advantage of the personalization features (and to what extent), and what proportion of the proportion exercises the provided e-commerce options compared to those not taking advantage of the personalization features.

The system endows content with its contextual relationship between viewer and other content, creating intelligence in the presentation itself. Such a system exceeds what third party ratings such as the Nielsen rating could do because of the continuous direct feedback provided to the system: the surveys are the actual users' interactions with the system. Even the most conscientious survey taker won't be able to capture such a level of detail.

Other advantages and features will become apparent from the following description, including the drawings and claims.

### BRIEF DESCRIPTION OF THE DRAWINGS

FIG. 1A shows an exemplary diagram showing the relationships among a user viewing content(s) in particular context(s).

FIG. 1B shows an exemplary presentation.

FIG. 2 shows one embodiment of a FABRIC for supporting customizable presentations.

FIG. 3 shows an exemplary operation for a local server.

FIG. 4 shows an exemplary authoring process.

FIG. 5 shows an exemplary process running on a viewing terminal.

FIG. 6 illustrates a process relating to content consumption within a browser/player.

FIG. 7 shows a process to enhance for user community participation.

### DESCRIPTION

Referring now to the drawings in greater detail, there is illustrated therein structure diagrams for the customizable content transmission system and logic flow diagrams for the processes a computer system will utilize to complete various content requests or transactions. It will be understood that the program is run on a computer that is capable of communication with consumers via a network, as will be more readily understood from a study of the diagrams.

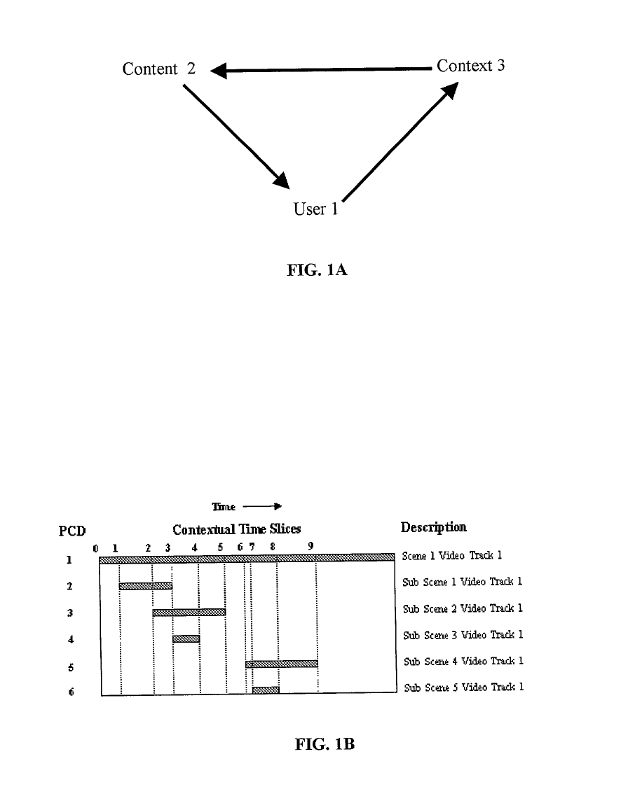

FIG. 1A shows an exemplary diagram showing the relationships among a user 1 viewing content 2 in particular context(s) 3. The user 1 interacts with a viewing system through a user interface that can be a graphical user interface (GUI), a voice user interface (VUI), or a combination thereof. Initially, the user 1 can simply request to see the content 2. The content 2 is streamed and played to the user. The user 1 can view the default stream, or can interact with the content 2 by selecting a different viewing angle, query for more information on a particular scene or actor/actress, for example. The user interest exhibited implicitly in his or her selection and request is captured as the context 3. The actions taken by the user 1 through the user interface is captured, and over time, the behavior of a particular user can be predicted based on the context 3. Thus, the user 1 can be presented with additional information associated with a particular program. For example, as the user 1 is browsing through the programs, he or she may wish to obtain more information relating to specific areas of interest or concerns associated with the show, such as the actors, actresses, other movies released during the same time period, or travel packages or promotions that may be available through primary, secondary or third party vendors. The captured context 3 is used to customize information to the viewer even with the multitude of programs broadcast every day. In addition, the system can rapidly update and provide the available information to viewers in real time. The combination of content 2 and context 3 is used to provide customized content, including advertising, to viewers.

FIG. 1B shows an exemplary presentation where a main presentation window is displayed along with a supplemental window running advertisements. In the following discussion, Presentation Context Descriptors (PCDs) designate the context embodied by a particular portion of mono-media content. Semantic descriptors (SDs) apply meanings to these PCDs, enabling various semantic properties of content to be distinguished. Semantic descriptors can from an acyclic relationship graph; the requisite relationships are mapped in the Semantic Relationships table. The relationships define a transitive equivalency flowing from specific to general, such that specific semantic instances also validate more general, inclusive semantics. The application of a semantic descriptor and a PCD occurs in a table called a semantic map, which furthermore supplies a nonzero weight less than or equal to one (default).

When a PCD becomes active, the SDs attributed to it are located via the semantic map. The score specified by the weight is added to the respective attribute subtotals located in a cumulative profile and session profile. For each attribute in question, transitive aggregation is applied for related SDs via the Semantic Relationship table, and applying the weight assigned to the relating attribute in the Semantic Map.

Turning now to FIG. 1B, the main presentation window is displayed along with a supplemental window running advertisements. The advertisements might be image-only banners while the main presentation is playing, but whenever it is paused, including when the presentation is halted pending user selection, a video or audio-video advertisement might run. For full screen mode, the window might temporarily split for these purposes.

At time 0, the viewer watches a basic audio-video clip. At this point, PCD 1 becomes valid, and the state change is communicated to the system. The following feedback process occurs:

The system locates attributes linked directly via the Semantic Map and indirectly via the Semantic Relationships table, and updates the aggregate scores located in the session and cumulative user state attributes. This value is part of the current context. Should the user pause presentation at this point, a commercial best fitting the current presentation context, the session context, or the user history could be selected via a comparison of attribute scores. In fact, any choice the user makes, the act will be logged along with the current context. Activation of context menu options, will yield contextual content options valid for the present context.

At time 1, the viewer continues to view the clip. PCD 2 becomes valid, while PCD 1 remains valid. The context state change for PCD 2 is sent to the system. The feedback process described at time 0 recurs.

At time 2, the viewer continues to view the clip. PCD 3 becomes valid, while PCDs 1 through 2 remain valid. The context state change for PCD 3 is passed to the system. The feedback process described at time 0 recurs.

At time 3, the viewer continues to view the clip. PCD 2 becomes invalid and PCD 4 becomes valid, while PCD 1 and 3 remain valid. The context state change for PCD 2 and 4 are sent to the system. The feedback process described at time 0 recurs.

At time 4, the viewer continues to view the clip. PCD 4 becomes invalid, while PCD 1 and 3 remain valid. The context state change for PCD 4 is communicated to the system. The feedback process described at time 0 recurs.

At time 5, the viewer continues to view the clip. PCD 3 becomes invalid, while PCD 1 remains valid. The context state change for PCD 3 is passed to the system. The feedback process described at time 0 recurs.

At time 6, the viewer continues to view the clip. PCD 5 becomes valid, while PCD 1 remains valid. The context state change for PCD 5 is passed to the system. The feedback process described at time 0 recurs.

At time 7, the viewer continues to view the clip. PCD 6 becomes valid, while PCD 1 and 5 remain valid. The context state change for PCD 6 is sent to the system. The feedback process described at time 0 recurs.

At time 8, the viewer continues to view the clip. PCD 6 becomes invalid, while PCD 1 and 5 remain valid. The context state change for PCD 6 is communicated to the system. The feedback process described at time 0 recurs.

At time 9, the viewer continues to view the clip. PCD 5 becomes invalid, while PCD 1 remains valid. The context state change for PCD 3 is passed to the system. The feedback process described at time 0 recurs.

In this example, multi-track streams, like multi-angle, were left out so as not to confuse the different notions of context. The semantics of interest here is context as metadata, not context as perspective. Context as perspective, of course, corresponds to alternate content, which has its own context. Context as metadata, corresponds more to content about the content, which perspective certainly qualifies for, but the notion of metadata is more encompassing, and shouldn't be limited by the context of perspective. In one embodiment, the system of FIGS. 1A and 1B can support DVD multi-angle and navigation in that the system can utilize behavioral analysis to customize the user's experience. By focusing on the more general case of metadata, a deeper understanding of the user's interest in certain contents or subsections thereof can be built.

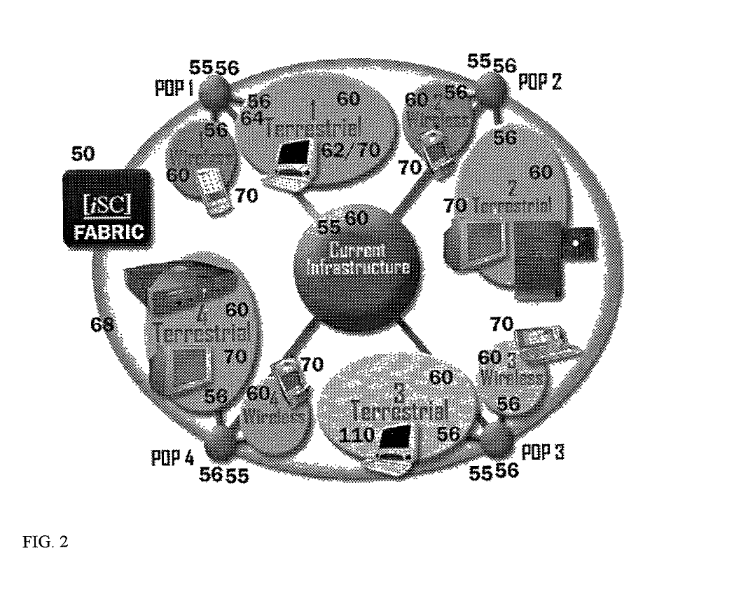

FIG. 2 shows an exemplary system that captures the context 3. The system also stores content 2, serves content 2 and streams the content 2, as modified in real-time by the context 3, to the user 1 on-demand. The system includes a switching FABRIC 50 connecting a plurality of networks 60. The switching FABRIC 50 provides an interconnection architecture which uses multiple stages of switches 56 to route transactions between a source address and a destination address of a data communications network. The switching FABRIC 50 includes multiple switching devices and is scalable because each of the switching devices of the FABRIC 50 includes a plurality of network ports and the number of switching devices of the FABRIC 50 may be increased to increase the number of network 60 connections for the switch. The FABRIC 50 includes all networks, which subscribe and are connected to each other and includes wireless networks, cable television networks, WAN's such as Exodus, Quest, DBN.

Computers 62 are connected to a network hub 64 that is connected to a switch 56, which can be an Asynchronous Transfer Mode (ATM) switch, for example. Network hub 64 functions to interface an ATM network to a non-ATM network, such as an Ethernet LAN, for example. Computer 62 is also directly connected to ATM switch 56. Multiple ATM switches are connected to WAN 68. The WAN 68 can communicate with FABRIC, which is the sum of all associated networks. FABRIC is the combination of hardware and software that moves data coming in to a network node out by the correct port (door) to the next node in the network.

Connected to the regional networks 60 can be viewing terminals 70. One or more regional servers 55 (RUE) processes transactions with the terminals 70 or computers 62 connected to its designated network. Each server 55 (RUE) includes a content database that can be customized and streamed on-demand to the user. Its central repository stores information about content assets, content pages, content structure, links, and user profiles, for example. Each regional server 55 (RUE) also captures usage information for each user, and based on data gathered over a period, can predict user interests based on historical usage information. Based on the predicted user interests and the content stored in the server, the server can customize the content to the user interest. The regional server 55 (RUE) can be a scalable compute farm to handle increases in processing load. After customizing content, the regional server 55 (RUE) communicates the customized content to the requesting viewing terminal 70.

The viewing terminals 70 can be a personal computer (PC), a television (TV) connected to a set-top box, a TV connected to a DVD player, a PC-TV, a wireless handheld computer or a cellular telephone. However, the system is not limited to any particular hardware configuration and will have increased utility as new combinations of computers, storage media, wireless transceivers and television systems are developed. In the following any of the above will sometimes be referred to as a “viewing terminal”. The program to be displayed may be transmitted as an analog signal, for example according to the NTSC standard utilized in the United States, or as a digital signal modulated onto an analog carrier, or as a digital stream sent over the Internet, or digital data stored on a DVD. The signals may be received over the Internet, cable, or wireless transmission such as TV, satellite or cellular transmissions.

In one embodiment, a viewing terminal 70 includes a processor that may be used solely to run a browser GUI and associated software, or the processor may be configured to run other applications, such as word processing, graphics, or the like. The viewing terminal's display can be used as both a television screen and a computer monitor. The terminal will include a number of input devices, such as a keyboard, a mouse and a remote control device, similar to the one described above. However, these input devices may be combined into a single device that inputs commands with keys, a trackball, pointing device, scrolling mechanism, voice activation or a combination thereof.

The terminal 70 can include a DVD player that is adapted to receive an enhanced DVD that, in combination with the regional server 55 (RUE), provides a custom rendering based on the content 2 and context 3. Desired content can be stored on a disc such as DVD and can be accessed, downloaded, and/or automatically upgraded, for example, via downloading from a satellite, transmission through the internet or other on-line service, or transmission through another land line such as coax cable, telephone line, optical fiber, or wireless technology.

An input device can be used to control the terminal and can be a remote control, keyboard, mouse, a voice activated interface or the like. The terminal may include a video capture mechanism such as a capture card connected to either live video, baseband video, or cable. The video capture card digitizes a video image and displays the video image in a window on the monitor. The terminal is also connected to a regional server 55 (RUE) over the Internet using various mechanisms. This can be a 56K modem, a cable modem, Wireless Connection or a DSL modem. Through this connection, the user connects to a suitable Internet service provider (ISP), which in turn is connected to the backbone of the network 68 such as the Internet, typically via a T1 or a T3 line. The ISP communicates with the viewing terminals 70 using a protocol such as point to point protocol (PPP) or a serial line Internet protocol (SLIP) 100 over one or more media or telephone network, including landline, wireless line, or a combination thereof On the terminal side, a similar PPP or SLIP layer is provided to communicate with the ISP. Further, a PPP or SLIP client layer communicates with the PPP or SLIP layer. Finally, a network aware GUI (VUI) receives and formats the data received over the Internet in a manner suitable for the user. As discussed in more detail below, the computers communicate using the functionality provided by MPEG 4 Protocol (ISO 14496). The World Wide Web (WWW) or simply the “Web” includes all the servers adhering to standard IP protocol. For example, communication can be provided over a communication medium. In some embodiments, the client and server may be coupled via Serial Line Internet Protocol (SLIP) or TCP/IP connections for high-capacity communication.

Active within the viewing terminal is a user interface (VUI) that establishes the connection with the server 55 and allows the user to access information. In one embodiment, the user interface (VUI) is a GUI that supports Moving Picture Experts Group-4 (MPEG-4), a standard used for coding audio-visual information (e.g., movies, video, music) in a digital compressed format. The major advantage of MPEG compared to other video and audio coding formats is that MPEG files are much smaller for the same quality using high quality compression techniques. In another embodiment, the GUI (VUI) can be on top of an operating system such as the Java operating system. More details on the GUI are disclosed in the copending application entitled “SYSTEMS AND METHODS FOR DISPLAYING A GRAPHICAL USER INTERFACE”, the content of which is incorporated by reference.

In another embodiment, the terminal 70 is an intelligent entertainment unit that plays DVD. The terminal 70 monitors usage pattern entered through the browser and updates the regional server 55 (RUE) with user context data. In response, the regional server 55 (RUE) can modify one or more objects stored on the DVD, and the updated or new objects can be downloaded from a satellite, transmitted through the internet or other on-line service, or transmitted through another land line such as coax cable, telephone line, optical fiber, or wireless technology back to the terminal. The terminal 70 in turn renders the new or updated object along with the other objects on the DVD to provide on-the-fly customization of a desired user view.

The system handles MPEG (Moving Picture Experts Group) streams between a server and one or more terminals using the switches. The server broadcasts channels or addresses which contain streams. These channels can be accessed by a terminal, which is a member of a WAN, using IP protocol. The switch, which sits at the gateway for a given WAN, allocates bandwidth to receive the channel requested. The initial Channel contains BiFS Layer Information, which the Switch can parse, process DMIF to determine the hardware profile for its network and determine the addresses for the AVO's needed to complete the defined presentation. The Switch passes the AVO's and the BiFS Layer information to a Multiplexor for final compilation prior to broadcast on to the WAN.

As specified by the MPEG-4 standard, the data streams (elementary streams, ES) that result from the coding process can be transmitted or stored separately, and need only to be composed so as to create the actual multimedia presentation at the receiver side. In MPEG-4, relationships between the audio-visual components that constitute a scene are described at two main levels. The Binary Format for Scenes (BIFS) describes the spatio-temporal arrangements of the objects in the scene. Viewers may have the possibility of interacting with the objects, e.g. by rearranging them on the scene or by changing their own point of view in a 3D virtual environment. The scene description provides a rich set of nodes for 2-D and 3-D composition operators and graphics primitives. At a lower level, Object Descriptors (ODs) define the relationship between the Elementary Streams pertinent to each object (e.g the audio and the video stream of a participant to a videoconference) ODs also provide additional information such as the URL needed to access the Elementary Steams, the characteristics of the decoders needed to parse them, intellectual property and others.

Media objects may need streaming data, which is conveyed in one or more elementary streams. An object descriptor identifies all streams associated to one media object. This allows handling hierarchically encoded data as well as the association of meta-information about the content (called ‘object content information’) and the intellectual property rights associated with it. Each stream itself is characterized by a set of descriptors for configuration information, e.g., to determine the required decoder resources and the precision of encoded timing information. Furthermore the descriptors may carry hints to the Quality of Service (QoS) it requests for transmission (e.g., maximum bit rate, bit error rate, priority, etc.) Synchronization of elementary streams is achieved through time stamping of individual access units within elementary streams. The synchronization layer manages the identification of such access units and the time stamping. Independent of the media type, this layer allows identification of the type of access unit (e.g., video or audio frames, scene description commands) in elementary streams, recovery of the media object's or scene description's time base, and it enables synchronization among them. The syntax of this layer is configurable in a large number of ways, allowing use in a broad spectrum of systems.

The synchronized delivery of streaming information from source to destination, exploiting different QoS as available from the network, is specified in terms of the synchronization layer and a delivery layer containing a two-layer multiplexer. The first multiplexing layer is managed according to the DMIF specification, part 6 of the MPEG-4 standard. (DMIF stands for Delivery Multimedia Integration Framework) This multiplex may be embodied by the MPEG-defined FlexMux tool, which allows grouping of Elementary Streams (ESs) with a low multiplexing overhead. Multiplexing at this layer may be used, for example, to group ES with similar QoS requirements, reduce the number of network connections or the end to end delay. The “TransMux” (Transport Multiplexing) layer models the layer that offers transport services matching the requested QoS.

Content can be broadcast allowing a system to access a channel, which contains the raw BiFS Layer. The BiFS Layer contains the necessary DMIF information needed to determine the configuration of the content. This can be looked at as a series of criteria filters, which address the relationships defined in the BiFS Layer for AVO relationships and priority.

DMIF and BiFS determine the capabilities of the device accessing the channel where the application resides, which can then determine the distribution of processing power between the server and the terminal device. Intelligence, built in to the FABRIC, will allow the entire network to utilize predictive analysis to configure itself to deliver QOS.

The switch 16 can monitor data flow to ensure no corruption happens. The switch also parses the ODs and the BiFSs to regulate which elements it passes to the multiplexer and which it does not. This will be determined based on the type of network the switch sits as a gate to and the DMIF information. This “Content Conformation” by the switch happens at gateways to a given WAN such as a Nokia 144k 3-G Wireless Network. These gateways send the multiplexed data to switches at its respective POP's where the database is installed for customized content interaction and “Rules Driven” Function Execution during broadcast of the content.

When content is authored, the BiFS can contain interaction rules that query a field in a database. The field can contain scripts that execute a series of “Rules Driven” (If/Then Statements), for example: If user “X” fits “Profile A” then access Channel 223 for AVO 4. This rules driven system can customize a particular object, for instance, customizing a generic can to reflect a Coke can, in a given scene.

Each POP send its current load status and QOS configuration to the gateway hub where Predictive Analysis is performed to handle load balancing of data streams and processor assignment to deliver consistent QOS for the entire network on the fly. The result is that content defines the configuration of the network once its BiFS Layer is parsed and checked against the available DMIF Configuration and network status. The switch also periodically takes snapshots of traffic and processor usage. The information is archived and the latest information is correlated with previously archived data for usage patterns that are used to predict the configuration of the network to provide optimum QOS. Thus, the network is constantly re-configuring itself.

The content on the FABRIC can be categorized in to two high level groups:

1. A/V (Audio and Video): Programs can be created which contain AVO's (Audio Video Objects), their relationships and behaviors (Defined in the BiFS Layer) as well as DMIF (Distributed Multimedia Interface Framework) for optimization of the content on various platforms. Content can be broadcast in an “Unmultiplexed” fashion by allowing the GLUI to access a channel which contains the Raw BiFS Layer. The BiFS Layer will contain the necessary DMIF information needed to determine the configuration of the content. This can be looked at as a series of criteria filters, which address the relationships defined in the BiFS Layer for AVO relationships and priority. In one exemplary application, a person using a connected wireless PDA, on a 3-G WAN, can request access to a given channel, for instance channel 345. The request transmits from the PDA over the wireless network and channel 345 is accessed. Channel 345 contains BiFS Layer information regarding a specific show. Within the BiFS Layer is the DMIF information, which says . . . If this content is being played on a PDA with access speed of 144k then access AVO 1, 3, 6, 13 and 22. The channels where these AVO's may be defined can be contained in the BiFS Layer of can be extensible by having the BiFS layer access a field on a related RRUE database which supports the content. This will allow for the elements of a program to be modified over time. A practical example of this systems application is as follows: a broadcaster transmitting content with a generic bottle can receive advertisement money from Coke another from Pepsi. The Actual label on the bottle will represent the advertiser when a viewer from a given area watches the content. The database can contain and command rules for far more complex behavior. If/Then Statements relative to the users profile and interaction with the content can produce customized experiences for each individual viewer on the fly.

2. Applications (ASP): Applications running on FABRIC represent the other type of Content. These applications can be developed to run on the servers and broadcast their interface to the GLUI of the connected devices. The impact of FABRIC and VUI enables 3^{rd} party developers to write an application such as a word processor that can send its interface, in for example, compressed JPEG format to the end users terminal device such as a wireless connected PDA.

An exemplary viewing customization is discussed next. In this example, the browser is the MPEG-4 enabled browser and MPEG-4 data is browsed. In the context of the MPEG specification, an elementary stream (ES) is a consecutive flow of mono-media from a single source entity to a single destination entity on the compression layer. An access unit (AU) is an individually accessible portion of data within an ES and is the smallest data entity to which timing information can be attributed. A presentation consists of a number of elementary streams representing audio, video, text, graphics, program controls and associated logic, composition information (i.e. Binary Format for Scenes), and purely descriptive data in which the application conveys presentation context descriptors (PCDs). If multiplexed, streams are demultiplexed before being passed to a decoder. Additional streams noted below are for purposes of perspective (multi-angle) for video, or language for audio and text. The following table shows each ES broken by access unit, decoded, then prepared for composition or transmission.

| | AUn | AU2 | AU1 | Decoder | Action |
|---|---|---|---|---|---|
| content | | | | | |
| elementary streams | An→ | A2→ | A1→ | video decode | scene composition |
| video base layer | An→ | A2→ | A1→ | video decode | scene composition |
| video enhancement layers | An→ | A2→ | A1→ | video decode | scene composition |
| additional video base layers | An→ | A2→ | A1→ | video decode | scene composition |
| additional video enhancement layers | An→ | A2→ | A1→ | video decode | scene composition |
| audio | An→ | A2→ | A1→ | audio decode | scene composition |
| additional audio | An→ | A2→ | A1→ | audio decode | scene composition |
| text overlay | An→ | A2→ | A1→ | text decode | scene composition |
| additional text overlays | An→ | A2→ | A1→ | text decode | scene composition |
| BiFS | An→ | A2→ | A1→ | BiFS parse | scene composition |
| context | | | | | |
| presentation context stream(s) | An→ | A2→ | A1→ | PCD parse | data transmission |
| | | | | | & context menu |
| | | | | | composition |

In this exemplary interactive presentation, a timeline indicates the progression of the scene. The content streams render the presentation proper, while presentation context descriptors reside in companion streams. Each descriptor indicates start and end time code. Pieces of context may freely overlap. As the scene plays: the current content streams are rendered, and the current context is transmitted over the network to the system. The presentation context is attributed to a particular ES, and each ES may or may not have contextual description. Presentation context of different ESs may reside in the same stream or different streams. Each presentation descriptor has a start and end flag, with a zero for both indicating a point in between. Whether or not descriptor information is repeated in each access unit corresponds to the random access characteristics of the associated content stream. For instance, predictive and bi-directional frames of MPEG video are not randomly accessible as they depend upon frames outside themselves. Therefore, in such cases, PCD info need not be repeated in such instances.

During the parsing stage of presentation context, it is determined whether the PCD is absolute, that is, its context is always active when its temporal definition is valid, or conditional, in which case it is only active upon user selection. In the latter case, the PCD refers to presentation content (not context) to jump to, enabling contextual navigation. The conditional context may also be regarded as interactive context. These PCDs include contextual information to display to the user within a context menu, which may involve alternate language translations.

Next, the presentation of a scene is discussed in conjunction with FIG. 1. The presentation involves the details of the scene, namely, who and what is in the scene, as well as what is happening. All of these elements contribute to the context of the scene. In the first case, items and characters in the scene, may have contextual relevance throughout their scene presence. In regards to what is happening, the relevant context tends to mirror the timeline of the activity in question.

Absolute context will just indicate a particular scene or segment has been reached to the system. This information can be used to funnel additional information outside of the main presentation, such as advertisements.

Interactive context is triggered by the user, unlike traditional menus. Interactive context provides a means for the user to access contextually related information via a context menu. A PCD will indicate what text and text properties to present to a user, as well as the hierarchical location within the menu. For instance, a scene with Robert DeNiro and Al Pacino meeting in a cafe, could specify contextual nodes related to DeNiro shown below. The bracketing depicts the positioning within the menu. Then end-actions, similar to the HREFs of HTML, have been omitted, but conform to the following format: <localStreamID=”” remoteStreamID=”” transitionStreamID=””>, which specifies where the content can be found, and depending on the connection type. For instance, content with no local streamID, would be grayed out or omitted, depending on the GUI preference, if no Internet connection was active. A transitional stream is a local placeholder used to increased perceived reponsiveness, and provides feedback in regards to stream acquisition.

<Actors><Robert DeNiro><list of credits>

<Actors><Robert DeNiro><interviews><with DeNiro about this movie>

<Actors><Robert DeNiro><interviews><on DeNiro in this movie>

<Actors><Robert DeNiro><interviews><other interviews with DeNiro>

<Actors><Robert DeNiro><interviews><other interviews on DeNiro>

<Actors><Robert DeNiro><tidbits>

The bracketing depicts the positioning within the menu. Then end-actions, similar to the HREFs of HTML, have been omitted, but conform to the following format: <localStreamID=”” remoteStreamID=”” transitionStreamID=””>, which specifies where the content can be found (not mutually exclusive), and depending on the connection type. For instance, content with no local streamID, would be grayed out or omitted, depending on the GUI preference, if no Internet connection was active. A transitional stream is a local placeholder used to increased perceived responsiveness, and provides feedback in regards to stream acquisition. It's a great opportunity for advertisements.

It's up to the author or information provider to decide how to structure context menus. Information in regards to background music, location, set props, and objects corresponding to brand names, such as clothing, could provide contextual information. Because the context will vary over the time, the addition of new interactive context is likely to be an ongoing process. Because the GUI is constantly providing feedback during online sessions, the system can pass new context in one or more additional presentation context streams.

People watch movies for various reasons and with various things in mind. Value-add subscriber services could cater to special interests such as those listed below.

movie buffs

entertainment (what the stars are up to)

cinemaphotography

backstage pass

fashion

All a presentation context descriptor does is define a region of content in regards to an elementary stream, and, optionally, define a context menu item positioned within an associated hierarchy. It functions like, and corresponds to, a database, key. As a descriptor is just a place holder, it is the use of semantic descriptors which generate meaning: that is, how the segment relates to other segments, and to the user, and by an extension, how a user relates to other users.

Semantic descriptors operate with context descriptors to create a collection of weighted attributes. Weighted attributes are applied to content segments, user histories, and advertisements, yielding a weight-based system for intelligent marketing. In one embodiment, the logic of rules-based data agents then comes down to structured query language. A semantic descriptor is itself no more than an identifier, a label, and a definition, which is enough to introduce categorization. Its power comes from its inter-relationship with other semantic descriptors. Take the following descriptors: playful, silly, funny, flirtatious, sexy, predatorial, and mischievous. The component “playful” can show up in very different contexts, such as humor (“silly”, “funny”), sexuality (“flirtatious”, “sexy”), and hunting/torture (think animals with their prey, the Penguin or Joker with the Dynamic Duo in their clutches, or all those villains who always get foiled because of their excessive playfulness. Now, while these different applications are very different, take someone who exhibits an appeal toward this very distinct trait of playfulness. Without this depth, to just say the user enjoys humor, sex, wildlife shows, and sexual suggestiveness, would be to miss the point, not to mention leading to some off-based recommendations.

Because the system stores what is watched by a particular installation (whether explicit selections or passive viewing) when and how often, along with the granularity of small segments, over time, the system takes note of what components are prevalent. Logging of activity is independent from the semantic modeling of the content, so that the current model is valid for time periods before it. This means that changes to the model can trigger corrections that must be processed in non-real-time. The relationship between descriptors flows from specific to general, for instance, flirtatiousness is a type of playfulness, so the semantics flow from flirtatious to playful, such that something flirtatious is also to be considered playful. Being silly can often be playful but not necessarily. There are different types of foolishness and silliness that should be clarified, such that one particular meaning of a word is meant in regards to a granular descriptor. Thus, a number after the label would indicate which one meaning of a term was meant. Being mischievous generally has a component of playfulness, but in regards to hunting and villainous capture, “playful” would be coincidental as opposed integral. The general strategy, however, is to locate the most granular descriptors and accumulate them into more refined meaning. Over time, the system is refined such that fine-tuning won't come initially, but even with little data, the system can distinguish various genres such as thrillers and sports.

A presentation context descriptor and a semantic descriptor are associated via a semantic presentation map tying the two descriptors and a relative weight. This adds a good degree of flexibility in scoring the prominence of attributes within content. It is up to a particular database agent to express the particular formula involved.

Referring back to the <actor> example, there might be three different advertisements. The system employs some degree of variance regardless of the profile in question, but all things considered equal, the best match in advertising will generally stem from an attribute-based correlation of the profile history at the installation, the current content being viewed, and the advertisements being considered, and some scoring criterion. Also, the system via contextual feedback, can anticipate in advance the need to perform the correlation. As a result, the system can anticipate and customize content when the user requests a particular action on the user interface.

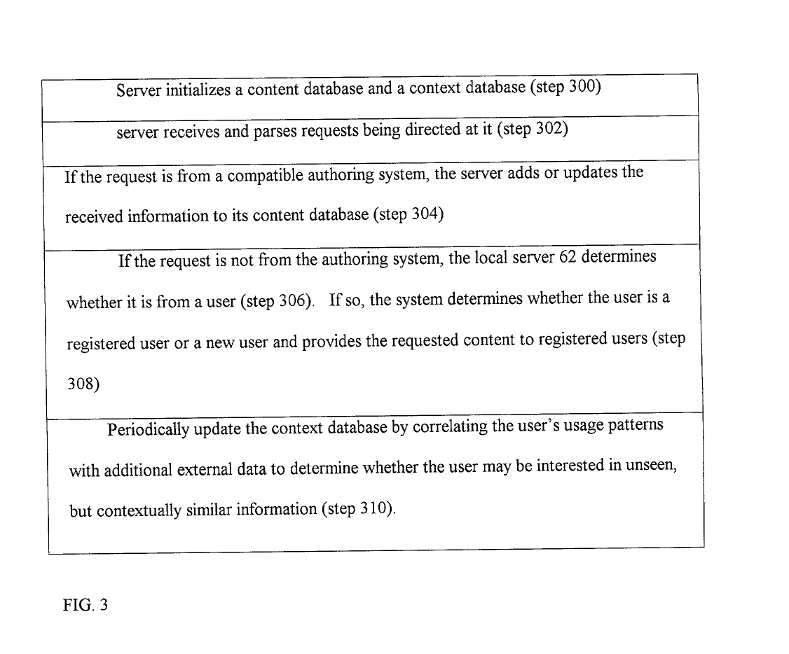

FIG. 3 shows an exemplary operation for the local server 62. First, the server 62 initializes a content database and a context database (step 300). Next, the server receives and parses requests being directed at it (step 302). If the request is from a compatible authoring system, the server adds or updates the received information to its content database (step 304). The content database provides a fine-grained categorization of one or more scenes in a particular movie, corporate presentation, video program, or multimedia content. Based on the categorization, context information could be applied. For example, a movie can have a hundred scenes. A content creator, such as a movie editor, would use the authoring system to annotate each scene using a predetermined format, for example an XML compatible format. The annotation tells the local server 62 the type of scene, the actor/actress involved, a list of objects that can be customized, and definitions so that the local server can retrieve and modify the objects. After all scenes have been annotated, the authoring system uploads the information to the local server 62.

From step 304, if the request is not from the authoring system, the local server 62 determines whether it is from a user (step 306). If so, the system determines whether the user is a registered user or a new user and provides the requested content to registered users. The local server 62 can send the default content, or can interactively generate alternate content by selecting a different viewing angle or generate more information on a particular scene or actor/actress, for example. The local server 62 receives in real-time actions taken by the user, and over time, the behavior of a particular user can be predicted based on the context database. For example, as the user is browsing through the programs, he or she may wish to obtain more information relating to specific areas of interest or concerns associated with the show, such as the actors, actresses, other movies released during the same time period, or travel packages or promotions that may be available through primary, secondary or third party vendors. The captured context is stored in the context database and used to customize information to the viewer even with the multitude of programs broadcast every day. In addition, the system can rapidly update and provide the available information to viewers in real time. After servicing the user, the process loops back to step 302 to handle the next request.

From step 302, periodically, the system updates the context database by correlating the user's usage patterns with additional external data to determine whether the user may be interested in unseen, but contextually similar information (step 310). This is done by data-mining the context database.

In one implementation, the server 62 finds groupings (clusters) in the data. Each cluster includes records that are more similar to members of the same cluster than they are similar to rest of the data. For example, in a marketing application, a company may want to decide who to target for an ad campaign based on historical data about a set of customers and how they responded to previous campaigns. Clustering techniques provide an automated process for analyzing the records of the collection and identifying clusters of records that have similar attributes. For example, the server can cluster the records into a predetermined number of clusters by identifying records that are most similar and place them into their respective cluster. Once the categories (e.g., classes and clusters) are established, the local server 62 can use the attributes of the categories to guide decisions. For example, if one category represents users who are mostly teenagers, then a web master may decide to include advertisements directed to teenagers in the web pages that are accessed by users in this category. However, the local server 62 may not want to include advertisements directed to teenagers on a certain presentation if users in a different category who are senior citizens also happen to access that presentation frequently. Each view can be customized to a particular user, so there are not static view configurations to worry about. Users can see the same content, but different advertisements.

In another implementation, a Naive-Bayes classifier can be used to perform the data mining. The Naive-Bayes classifier uses Bayes rule to compute the probability of each class given an instance, assuming attributes are conditionally independent given a label. The Naive-Bayes classifier requires estimation of the conditional probabilities for each attribute value given the label. For discrete data, because only few parameters need to be estimated, the estimates tend to stabilize quickly and more data does not change the model much. With continuous attributes, discretization is likely to form more intervals as more data is available, thus increasing the representation power. However, even with continuous data, the discretization is usually global and cannot take into account attribute interactions. Generally, Naive-Bayes classifiers are preferred when there are many irrelevant features. The Naive-Bayes classifiers are robust to irrelevant attributes and classification takes into account evidence from many attributes to make the final prediction, a property that is useful in many cases where there is no “main effect.” Also, the Naive-Bayes classifiers are optimal when the assumption that attributes are conditionally independent hold, e.g., in medical practice. On the downside, the Naive-Bayes classifiers require making strong independence assumptions. When these assumptions are violated, the achievable accuracy may asymptote early and will not improve much as the database size increases.

Other data-mining techniques can be used. For example, a Decision-Tree classifier can be used. This classifier assigns each record to a class, and the Decision-Tree classifier is induced (generated) automatically from data. The data, which is made up of records and a label associated with each record, is called the training set. Decision-Trees are commonly built by recursive partitioning. A univariate (single attribute) split is chosen for the root of the tree using some criterion (e.g., mutual information, gain-ratio, gini index). The data is then divided according to the test, and the process repeats recursively for each child. After a full tree is built, a pruning step is executed which reduces the tree size. Generally, Decision-Trees are preferred where serial tasks are involved, i.e., once the value of a key feature is known, dependencies and distributions change. Also, Decision-Trees are preferred where segmenting data into sub-populations gives easier subproblems. Also, Decision-Trees are preferred where there are key features, i.e., some features are more important than others.

In yet another implementation, a hybrid classifier, called the NB-Tree hybrid classifier, is generated for classifying a set of records. As discussed in U.S. Pat. No. 6,182,058, each record has a plurality of attributes. According to the present invention, the NB-Tree classifier includes a Decision-Tree structure having zero or more decision-nodes and one or more leafnodes. At each decision-node, a test is performed based on one or more attributes. At each leaf-node, a classifier based on Bayes Rule classifies the records.

The result of the data-mining operation is used to update the context database so that the next time the user views information, the local server 62 can automatically customize the content exactly to the user's wishes.

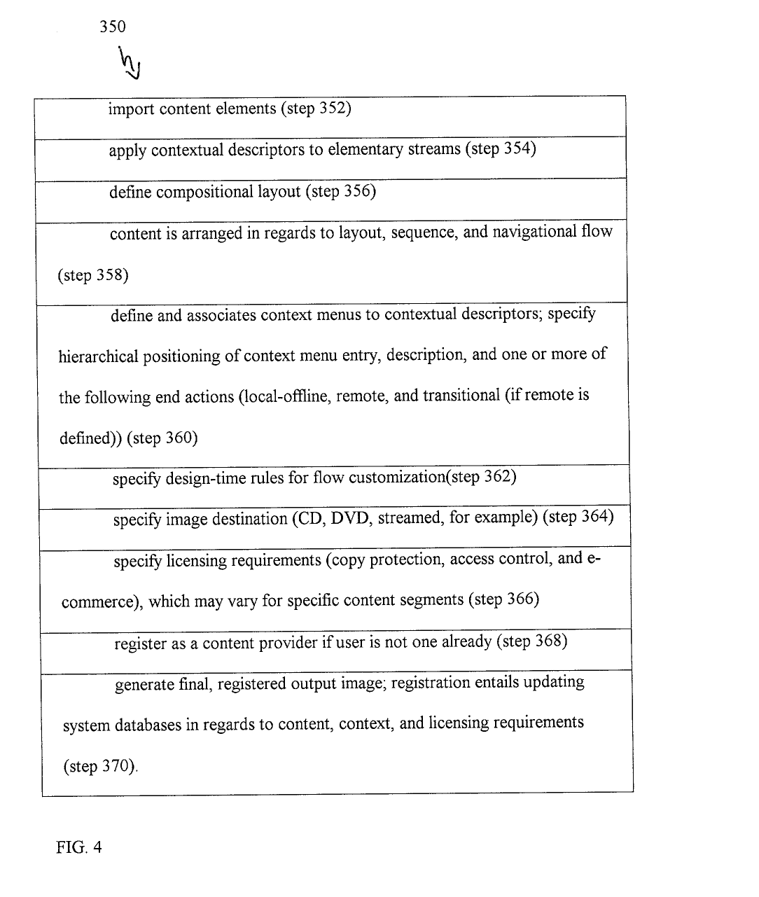

Referring now to FIG. 4, a process 350 for authoring content and registering the new content with the local server 62 is shown. The process 350 is executed by the Authoring System at Design Time. First, a user imports content elements (step 352). Next, the user applies contextual descriptors to elementary streams: MPEG-7 layer information, for example (step 354). The user can also define compositional layout, such as multiple windows or event specific popups and certain content meant to be displayed in a windowed presentation can make use of the popups, for example (step 356). The content is arranged in regards to layout, sequence, and navigational flow (step 358). In this step, the user can also specify navigational interactivity; examples of navigational interactivity are: anchors (clickable targets), forms, alternate tracks and context menus, virtual presence (VRML-like navigation), and interactive stop mode, where playback breaks periodically pending user interaction, which determines flow control. The user then defines and associates context menus to contextual descriptors; specify hierarchical positioning of context menu entry, description, and one or more of the following end actions (local-offline, remote, and transitional (if remote is defined)) (step 360). The user can specify design-time rules for flow customization(step 362). Next, the user can specify image destination (CD, DVD, streamed, for example) (step 364). The user can also specify licensing requirements (copy protection, access control, and e-commerce), which may vary for specific content segments (step 366). The user then registers as a content provider if he or she is not one already (step 368). Additionally, the user can generate final, registered output image; registration entails updating system databases in regards to content, context, and licensing requirements (step 370).

Using the above steps, the user imports components or assets into a particular project and edits the assets and annotates the assets with information that can be used to customize the presentation of the resulting content. The authoring system can also associate URLs with chapter points in movies and buttons in menus. A timeline layout for video is provided which supports the kind of assemble editing users expect from NLE systems. Multiple video clips can simply be dropped or rearranged on the timeline. Heads and Tails of clips can be trimmed and the resulting output is MPEG compliant. The user can also generate active button menus over movies using subpictures and active button hotspots on movies for interactive and training titles.

The above steps to author contextually-dependent, value-add content are the same as with initial content authoring, except that instead of, or in addition to, arranging content flow, contextual triggers are defined to make available the various contextual segments; primary linkage, then, depends upon external content.

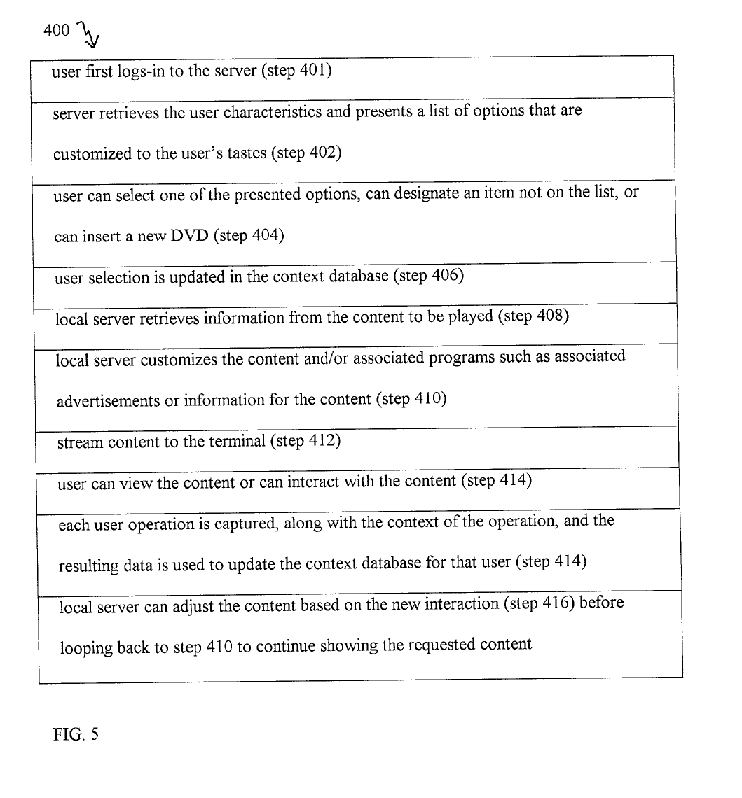

Turning now to FIG. 5, a process 400 running on the local terminal 70 is shown. The user first logs-in to the server (step 401). The server retrieves the user characteristics and presents a list of options that are customized to the user's tastes (step 402). The options can include a custom list of movies, sport programs, financial presentations, among others, that the user has viewed in the past or is likely to watch. The user can select one of the presented options, can designate an item not on the list, or can insert a new DVD (step 404). The user selection is updated in the context database (step 406) and the local server 62 retrieves information from the content to be played (step 408). For example, if the user has inserted a new DVD, the local server 62 identifies the DVD and search in its content database for customizable objects and information relating to the content. Based on the content database, the local server customizes the content and/or associated programs such as associated advertisements or information for the content (step 410) and streams the content to the terminal 70 (step 412). The user can passively view the content, or can interact with the content by selecting different viewing angles, can query certain information relating to the scene or the actors and actresses involved, or can interact with a commercial if desired (step 414). Each user operation is captured, along with the context of the operation, and the resulting data is used to update the context database for that user (step 414). The local server can adjust the content based on the new interaction (step 416) before looping back to step 410 to continue showing the requested content. The process thus provides customized content to the user, and allows the user to link, search, select, retrieve, initiate a subscription to and interact with information on the DVD as well as supplemental value-added information from a remote database, computer network or on-line server, e.g., a network server on the Internet or World Wide Web.

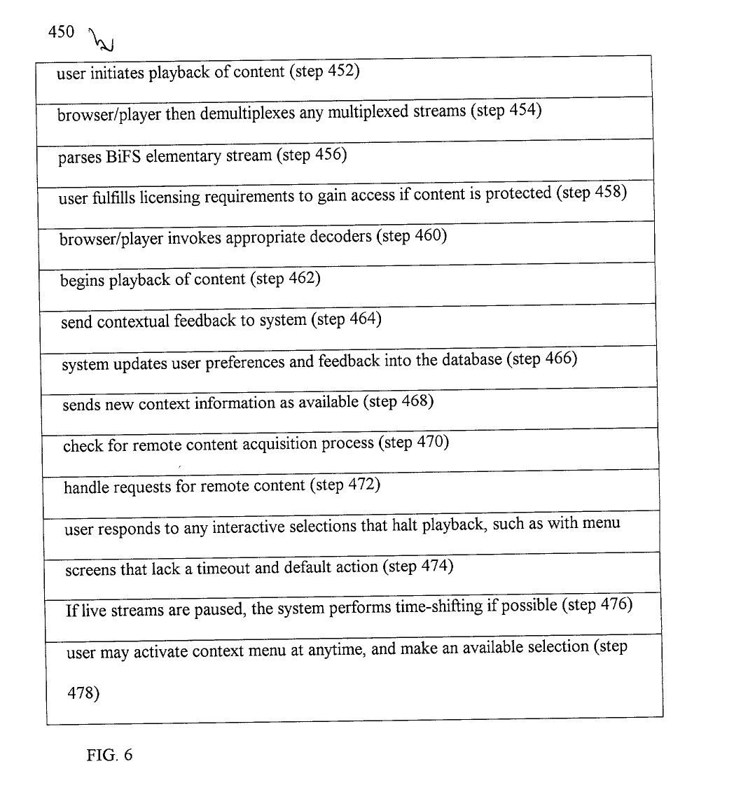

FIG. 6 illustrates a process 450 relating to content consumption within a browser/player. First, a user initiates playback of content (step 452). The browser/player then demultiplexes any multiplexed streams (step 454) and parses a BiFS elementary stream (step 456). The user then fulfill any necessary licensing requirements to gain access if content is protected, this could be ongoing in the event of new content acquisitions (step 458). Next, the browser/player invokes appropriate decoders (step 460) and begins playback of content (step 462). The browser/player continues to send contextual feedback to system (step 464), and the system updates user preferences and feedback into the database (step 466). The system captures transport operations such as fast forward and rewind, generate context information, as they are an aspect of how users interact with the title; for instance, what segments users tend to skip, and which users tend to watch repeatedly, are of interest to the system. In one embodiment, the system logs the user and stores the contextual feedback, applying any relative weights assigned in the Semantic Map, and utilizing the Semantic Relationships table for indirect assignments, an intermediate table should be employed for optimized resolution; the assignment of relative weights is reflected in the active user state information. Next, system sends new context information as available, such as new context menu items (step 468). The system may utilize rules-based logic, such as for sending customer focused advertisements, unless there are multiple windows, this would tend to occur during the remote content acquisition process (step 470). The system then handles requests for remote content (step 472).

After viewing the content, the user responds to any interactive selections that halt playback, such as with menu screens that lack a timeout and default action (step 474). If live streams are paused, the system performs time-shifting if possible (step 476). The user may activate context menu at anytime, and make an available selection (step 478). The selection may be subject to parental control specified in the configuration of the player or browser.

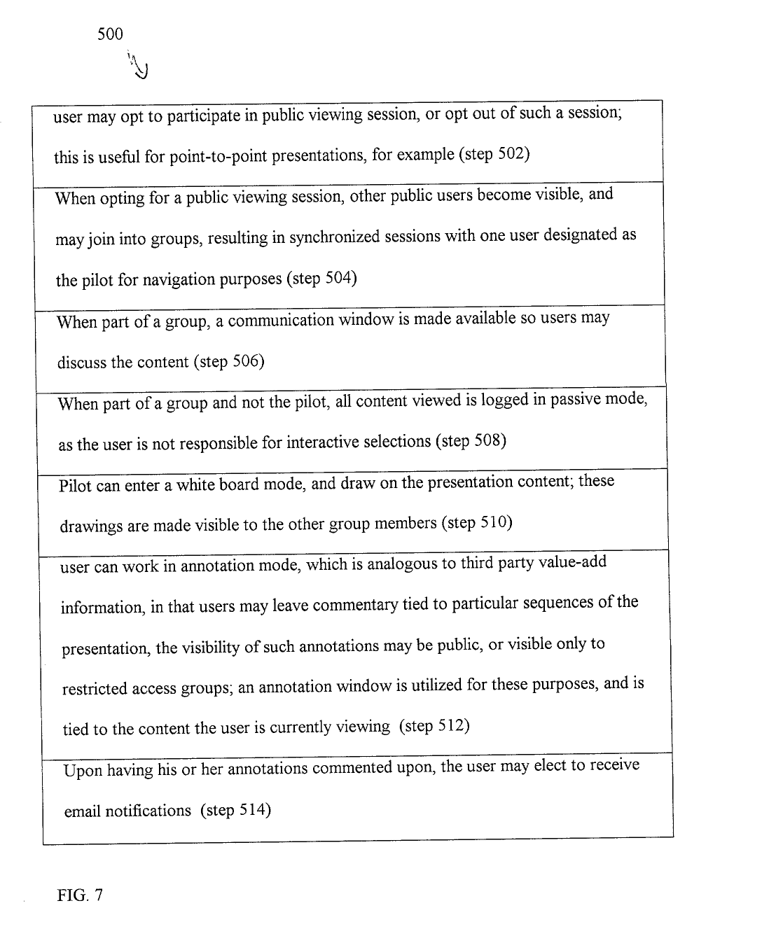

Turning now to FIG. 7, a process 500 to enhance for user community participation is shown. A user may opt to participate in public viewing session, or opt out of such a session; this is useful for point-to-point presentations, for example (step 502). When opting for a public viewing session, other public users become visible, and may join into groups, resulting in synchronized sessions with one user designated as the pilot for navigation purposes (step 504). When part of a group, a communication window is made available so users may discuss the content (step 506). When part of a group and not the pilot, all content viewed is logged in passive mode, as the user is not responsible for interactive selections (step 508). The pilot can enter a white board mode, and draw on the presentation content; these drawings are made visible to the other group members (step 510). The user may opt to work in annotation mode, which is analogous to third party value-add information, in that users may leave commentary tied to particular sequences of the presentation, the visibility of such annotations may be public, or visible only to restricted access groups; an annotation window is utilized for these purposes, and is tied to the content the user is currently viewing (step 512). Upon having his or her annotations commented upon, the user may elect to receive email notifications (step 514).

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

What is claimed is:

1. A method for presenting customized content to a viewer, comprising:
a. archiving the viewer's behavior on a server coupled to a wide area network and collecting the viewer's preferences over time;
b. receiving a request for a selected audio or video content;
c. dynamically generating customized audio or video content according to the viewer's preferences,
d. merging the dynamically generated customized audio or video content with the selected audio or video content; and
e. displaying the customized audio or video content to the viewer.

2. The method of claim 1, further comprising registering content with the server.

3. The method of claim 2, further comprising annotating the content with scene information.

4. The method of claim 3, wherein the viewer's behavior is correlated with the scene information.

5. The method of claim 3, further comprising correlating additional audio

6. or video content with an annotation.

7. The method of claim 3, further comprising correlating additional audio

8. or video content with scene information.

9. The method of claim 2, wherein the scene information includes one or more of the following: background music, location, set props, and objects corresponding to brand names.

10. The method of claim 2, further comprising adding customized advertisement to the customized video content.

11. The method of claim 1, further comprising generating a presentation context descriptor and a semantic descriptor.

12. The method of claim 11, further comprising associating the descriptors using a semantic presentation map that ties the descriptors with a relative weight.

13. The method of claim 12, further comprising scoring the prominence of attributes within content.

14. The method of claim 13, further comprising expressing a scoring formula by a database agent.

15. The method of claim 1, further comprising providing an interactive community participation.

16. The method of claim 1, comprising generating an acyclic tree of semantic descriptors.

17. The method of claim 16, further comprising applying a transitive association from semantic definitions to specific semantics.

18. The method of claim 17, wherein the definitions include more general definitions to score weighted attributes.
